(19) United States
(12) Patent Application Publication
(10) Pub. No.: US 2003/0172173 A1
(43) Pub. Date: Sep. 11, 2003

(54) Method, apparatus and system for reformatting a multimedia message for delivery to a terminal during connectionless communications

(76) Inventor: Gregg A. Fenton, Northport, NY (US)

Correspondence Address: ERICSSON INC., 6300 LEGACY DRIVE, M/S EVW2-C-2, PLANO, TX, 75024, US

(21) Appl. No.: 10/095,751

(22) Filed: Mar. 11, 2002

(51) Int. Cl. G06F 15/16

(52) U.S. Cl. 709/231; 709/246

(57) ABSTRACT

The present invention provides a method, apparatus and system for delivery to a terminal during connectionless communications. The present invention sends a first multimedia message notification (306) to the terminal (302). Whenever the terminal (302) rejects delivery (310) of the multimedia message, the present invention requests (312) one or more capabilities of the terminal (302), reformats (316) the multimedia message based on the requested capabilities and sends a second multimedia message notification (318) to the terminal (302). Whenever the terminal (302) accepts delivery (322) of the multimedia message, the present invention sends the reformatted multimedia message (326) to the terminal (302). This method can be implemented using a computer program embodied on a computer readable medium wherein each function is executed using a code segment.

### TECHNICAL FIELD OF THE INVENTION

The present invention relates generally to the field of communications and, more particularly, to a method, apparatus and system for reformatting a multimedia message for delivery to a terminal during connectionless communications.

### BACKGROUND OF THE INVENTION

Multimedia consists of one or more media elements, such as text, voice, image and video, and it is the combination of these media elements in an ordered synchronized manner that creates a multimedia presentation, which is also referred to as multimedia content. A non-real time multimedia message as observed by the user is a combination of one or more different media elements in a multimedia presentation that can be transferred between users without having to be transferred in real time.

With the popularity of the Internet and increased capability of personal computers, multimedia technology has and continues to rapidly develop to allow new capabilities, such as multimedia messages, games, presentations and services that are now considered to be a part of every day life. Moreover, the reduced size and increased capabilities of handheld devices, such as personal data assistants (“PDAs”), mobile phones and combinations thereof, have made the delivery of multimedia content to such devices more of a possibility. Most of these user terminals have different capabilities with respect to available memory, display size and display type. As a result a terminal may reject delivery of a particular multimedia message if the multimedia message exceeds the capabilities of the terminal.

There is, therefore, a need for a method, apparatus and system for reformatting a multimedia message for delivery to a terminal during connectionless communications.

### SUMMARY OF THE INVENTION

The present invention provides a flexible architecture that supports present and future multimedia messaging technologies and reformats multimedia messages for delivery to terminals during connectionless communications. As a result, any given terminal will reject fewer multimedia messages due to situations where the multimedia message exceeds the capabilities of the terminal. Moreover, the present invention can optimize the reformatting of the multimedia message based on one or more terminal or operating criteria.

The present invention provides a method of reformatting a multimedia message for delivery to a terminal during connectionless communications. The present invention sends a first multimedia message notification to the terminal. Whenever the terminal rejects delivery of the multimedia message, the present invention requests one or more capabilities of the terminal, reformats the multimedia message based on the requested capabilities and sends a second multimedia message notification to the terminal. Whenever the terminal accepts delivery of the multimedia message, the present invention sends the reformatted multimedia message to the terminal. This method can be implemented using a computer program embodied on a computer readable medium wherein each function is executed using a code segment.

In addition, the present invention provides a system for reformatting a multimedia message during connectionless communications that includes a terminal and a server. The server sends a first multimedia message notification to the terminal. Whenever the terminal rejects delivery of the multimedia message, the server requests one or more capabilities of the terminal, reformats the multimedia message based on the requested capabilities and sends a second multimedia message notification to the terminal. Whenever the terminal accepts delivery of the multimedia message, the server sends the reformatted multimedia message to the terminal.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram illustrating a multimedia messaging system in accordance with an embodiment of the present invention;

FIGS. 2A and 2B are sequence diagrams illustrating the acceptance and rejection of a multimedia message by a terminal in accordance with the prior art; and

FIG. 3 is a sequence diagram illustrating the acceptance of a multimedia message by a terminal in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a flexible architecture that supports present and future multimedia messaging technologies and reformats multimedia messages for delivery to terminals during connectionless communications. As a result, any given terminal will reject fewer multimedia messages due to situations where the multimedia message exceeds the capabilities of the terminal. Moreover, the present invention can optimize the reformatting of the multimedia message based on one or more terminal or operating criteria.

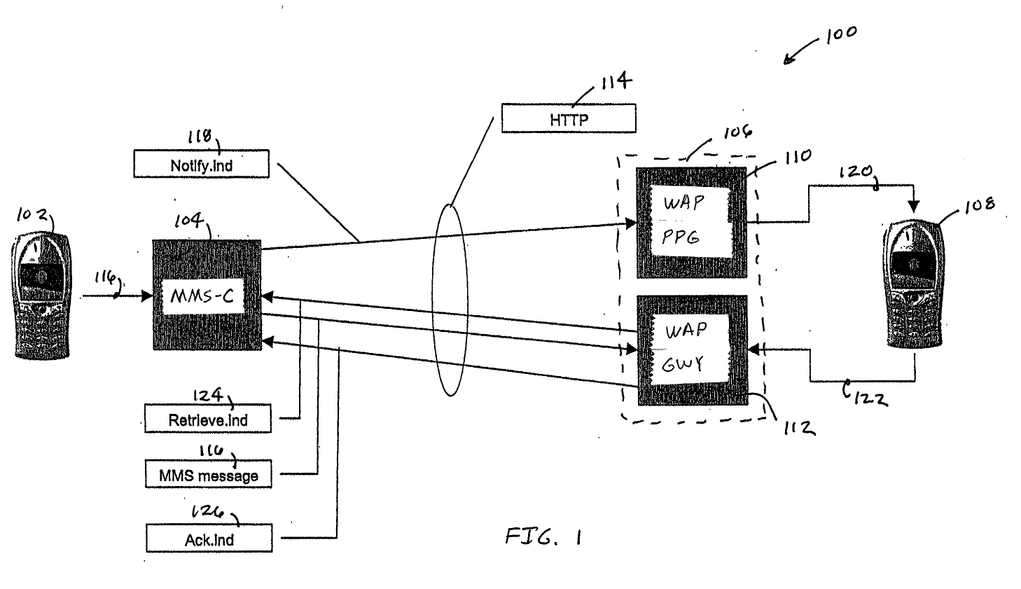

Referring to FIG. 1, a block diagram illustrating a multimedia messaging system 100 in accordance with an embodiment of the present invention. The system 100 includes a sending user's terminal 102, a multimedia service center (“MMS-C”) 104, a message gateway 106 and a receiving user's terminal 108. The sending and receiving user's terminals 102 and 108 are both multimedia compatible. In addition, the sending and receiving user's terminals 102 and 108 are communicably connected to the multimedia service center 104 and message gateway 106, respectively, via one or more communication networks, such as fixed networks, mobile networks, Global System for Mobile Communications (“GSM”) second generation (“2G”) mobile networks, third generation (“3G”) mobile networks and Internet/IP networks. The MMS-C 104 is responsible for storage and handling of incoming and outgoing multimedia messages and for the transfer of multimedia messages between different messaging systems. The message gateway 106 is responsible for notifying the receiving user's terminal 108 that a multimedia message is ready for delivery and subsequently handles the delivery of the multimedia message to the receiving user's terminal 108. The message gateway 106 may include a WAP/Push Proxy Gateway (“WAP PPG”) 110 and a WAP gateway 112. Alternatively, the message gateway 106 may include a SMSC in place of the WAP PPG 110 and a web browser in place of the WAP gateway 112. The MMS-C 104 is communicably connected to the message gateway 106 via a network that uses standard Internet-type protocols 114, such as Hypertext Transfer Protocol (“HTTP”).

In operation, the sending user's terminal 102 sends the multimedia message 116 to the MMS-C 104 where it is stored pending delivery to the receiving user's terminal 108. The MMS-C 104 sends a notification 118 (Notify.Ind) to the WAP PPG 110, which in turn sends a multimedia message notification 120 to the receiving user's terminal 108 indicating that the multimedia message 116 has been received and is ready for delivery. When the user wants to receive the multimedia message 116, he or she sends a retrieve message 122 from the receiving user's terminal 108 to the WAP gateway 112, which sends a retrieval request 124 (Retrieve.Ind) to the MMS-C 104. Alternatively, the user terminal 108 may automatically send the retrieve message 122 after checking the capability of the terminal 108 to receive the multimedia message 116. The MMS-C 104 sends the multimedia message 116 to the WAP gateway 112, which forwards the multimedia message 116 to the receiving user's terminal 108 and sends an acknowledgment 126 (Ack.Ind) back to the MMS-C 104 indicating that the multimedia message 116 has been received. As previously mentioned, the multimedia message 116 may include text, pictures and audio files. The picture may be encoded in JPEG, GIF 89a, GIF 89b, PNG, MNG or WBMP formats.

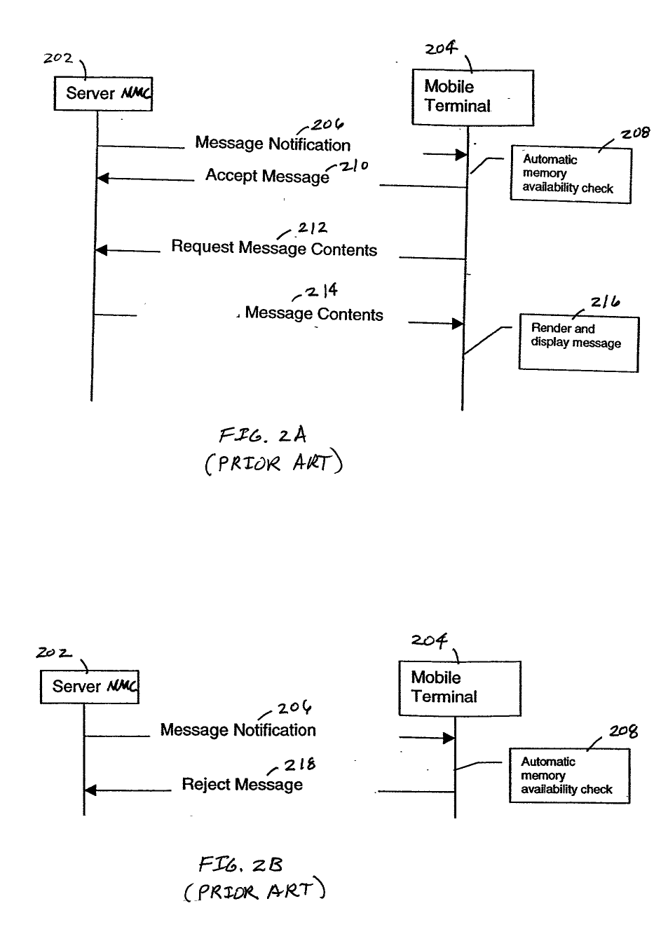

Now referring briefly to and discussing the prior art in reference to FIGS. 2A and 2B, sequence diagrams illustrating the acceptance and rejection of a multimedia message by a terminal in accordance with the prior art are shown. A two stage delivery mechanism is employed to deliver multimedia content to a mobile terminal. This two stage process is used because the data connection is initiated by the terminal 204 instead of by the server 202 or network. A separate notification to the terminal 204 is required for the terminal 204 to establish the session.

With respect to the acceptance sequence shown in FIG. 2A, the server or MMS-C 202 sends a multimedia message notification 206 to the mobile terminal 204. The multimedia message notification 206 contains the originator of the multimedia message, the expiration of the multimedia message and the size of the multimedia message. The content of the multimedia message is not stated at this time. This notification process is performed in a connectionless environment, such that the server 202 is not in direct communication with the terminal 204. The terminal 204 then performs an automatic memory availability check 208 to determine whether the multimedia message can be stored within the terminal 204 on a subsequent message download. Note that other capabilities of the terminal 204 may also be checked. Upon a successful automatic memory availability check 208, the terminal 204 may optionally send an accept 210 the multimedia message. Thereafter, the terminal 208 requests the multimedia message contents 212 from the server 202, which then sends the multimedia message contents 214 to the terminal 204. The terminal 204 then renders and displays the multimedia message 216.

With respect to the rejection sequence shown in FIG. 2B, the server or MMS-C 202 sends a multimedia message notification 206 to the mobile terminal 204, which then performs an automatic memory availability check 208. Note that other capabilities of the terminal 204 may also be checked. If the automatic memory availability check 208 fails, the terminal 204 rejects the multimedia message 218 and the multimedia message is not delivered. Note that the rejection message 218 does not necessarily indicate the exact cause of the rejection. Upon receipt of the rejection message 218, the server 204 may terminate any further attempts to deliver the content.

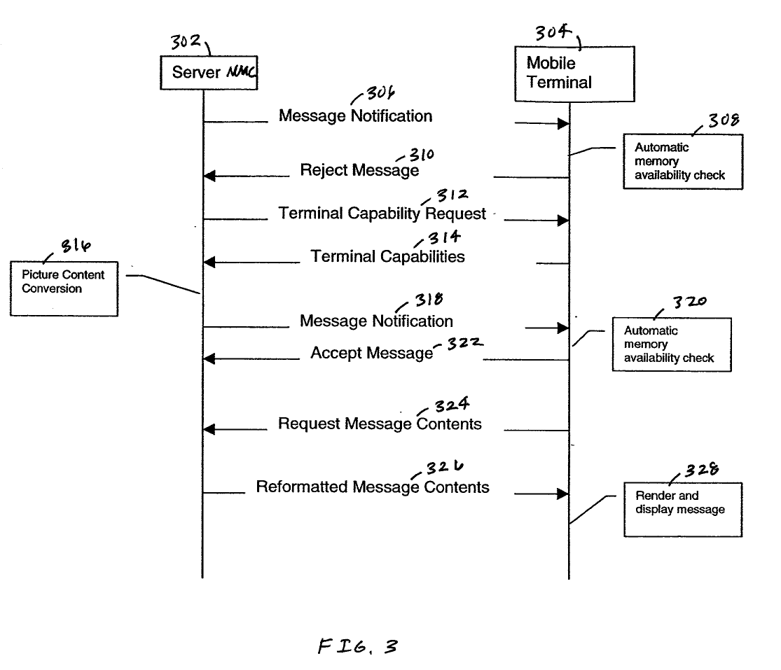

Now turning back to the discussion of the present invention in reference to FIG. 3, a sequence diagram illustrating the acceptance of a multimedia message by a mobile terminal 304 in accordance with one embodiment of the present invention is shown. The server or MMS-C 302 sends a first multimedia message notification 306 to the terminal 304. The terminal 304 then performs an automatic memory availability check 308 to determine whether the multimedia message can be stored within the terminal 304 on a subsequent message download. Note that other capabilities of the terminal 304 may also be checked at this time. Whenever the terminal 304 rejects delivery 310 of the multimedia message, the present invention requests one or more capabilities 312 of the terminal 304 or other system cognizant of the one or more capabilities 312 of the terminal 304, and subsequently receives the requested capabilities 314 of the terminal 304. For example, the one or more capabilities 312 can be derived by examining the equipment identifier (“IMEI”) that is unique to each terminal 304 and terminal manufacturer. The one or more capabilities 312 typically involve the picture rendering capabilities, the amount of memory available for multimedia content, the size of the display and the type of the display (e.g., 256 color, black and white, etc.), and the audio playback capability. This information may be derived from basic information available from the terminal 304 or other system cognizant of the one or more capabilities 312 of the terminal 304 or commonly available known capabilities 312 of the terminal 304. With this information, the server 302 can determine whether the multimedia message was rejected due to not enough memory within the terminal 304 or some other reason. The server 302 then reformats 316 the multimedia message based on the requested capabilities, which will typically involve a picture content conversion.

For example, reformatting 316 may include conversion of the picture to a size compatible with the terminal 304, or conversion of the picture to a method compatible with the display format (i.e. reduction of the picture resolution to 256 colors, elimination of color aspects, etc.), or conversion of the picture compression to reduce the size of the file but maintain the rendering capabilities within the terminal 304 (i.e. convert from JPEG to GIF89a, reduce size of the image, etc.). Conversion may also include audio format re-encoding to reduce the overall size of the multimedia message (e.g. WAV to AMR, etc.), make the audio format compatible with the playback format of the terminal 304 or optimize it for playback on the terminal 304. The server 302 then sends a second multimedia message notification 318 containing updated information about the reformatted multimedia message to the terminal 304. The terminal 304 repeats its automatic memory availability check 320 as previously described. Whenever the terminal 304 accepts delivery 322 of the multimedia message, the terminal 304 later requests the multimedia message contents 324. The server 302 sends the reformatted multimedia message 326 to the terminal 304. The terminal 304 then renders and displays the multimedia message 328.

The order and performance of the steps described above is dependant upon the capability of the terminal 304 and the effectiveness of reduction in size of the multimedia message to comply with the one or more capabilities of the terminal 304. Preferably, the reformatting 316 should be optimized such that the resolution of the content is maximized to the highest extent to allow the original multimedia message presentation to be maintained at the highest degree of quality. These method can be implemented using a computer program embodied on a computer readable medium wherein each function is executed using a code segment.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method of reformatting a multimedia message for delivery to a terminal during connectionless communications comprising the steps of:
sending a first multimedia message notification to the terminal;
whenever the terminal rejects delivery of the multimedia message:
requesting one or more capabilities of the terminal,
reformatting the multimedia message based on the requested capabilities, and
sending a second multimedia message notification to the terminal; and
sending the reformatted multimedia message to the terminal whenever the terminal accepts delivery of the multimedia message.

2. The method as recited in claim 1, further comprising the steps of:
determining which of the requested capabilities caused the terminal to reject delivery of the multimedia message; and
wherein the reformatting of the multimedia message is based on the requested capabilities that were determined to cause the terminal to reject delivery of the multimedia message.

3. The method as recited in claim 1, wherein the reformatting is optimized to maximize resolution of the content of the multimedia message.

4. The method as recited in claim 1, wherein the step of reformatting the multimedia message comprises the step of converting the multimedia content within the multimedia message to a type compatible with the terminal.

5. The method as recited in claim 1, wherein the step of reformatting the multimedia message comprises the step of converting the multimedia content within the multimedia message to a format compatible with the terminal.

6. The method as recited in claim 1, wherein the step of reformatting the multimedia message comprises the step of converting the multimedia content within the multimedia message to a resolution compatible with the terminal.

7. The method as recited in claim 1, wherein the step of reformatting the multimedia message comprises the step of reducing the size of the multimedia message to a size compatible with the terminal.

8. The method as recited in claim 1, wherein the step of reformatting the multimedia message comprises the step of re-encoding the audio format of the multimedia message to be compatible with the playback format of the terminal.

9. The method as recited in claim 1, wherein the one or more capabilities of the terminal are obtained from the terminal.

10. The method as recited in claim 1, wherein the one or more capabilities of the terminal are obtained from a system cognizant of the one or more capabilities of the terminal.

11. The method as recited in claim 1, wherein the one or more capabilities of the terminal are obtained from commonly available known capabilities of the terminal.

12. A computer program embodied on a computer-readable medium for reformatting a multimedia message for delivery to a terminal during connectionless communications comprising:
a code segment adapted to sending a first multimedia message notification to the terminal;
whenever the terminal rejects delivery of the multimedia message:
a code segment adapted to request one or more capabilities of the terminal,
a code segment adapted to reformat the multimedia message based on the requested capabilities, and
a code segment adapted to send a second multimedia message notification to the terminal; and
a code segment adapted to sending the reformatted multimedia message to the terminal whenever the terminal accepts delivery of the multimedia message.

13. The computer program as recited in claim 12, further comprising:
a code segment adapted to determining which of the requested capabilities caused the terminal to reject delivery of the multimedia message; and
wherein the reformatting of the multimedia message is based on the requested capabilities that were determined to cause the terminal to reject delivery of the multimedia message.

14. The computer program as recited in claim 12, wherein the reformatting is optimized to maximize resolution of the content of the multimedia message.

15. The computer program as recited in claim 12, wherein the code segment is adapted to reformat the multimedia message comprises a code segment adapted to converting the multimedia content within the multimedia message to a type compatible with the terminal.

16. The computer program as recited in claim 12, wherein the code segment adapted to reformat the multimedia message comprises a code segment adapted to converting the multimedia content within the multimedia message to a format compatible with the terminal.

17. The computer program as recited in claim 12, wherein the code segment adapted to reformat the multimedia message comprises a code segment adapted to converting the multimedia content within the multimedia message to a resolution compatible with the terminal.

18. The method as recited in claim 12, wherein the step of reformatting the multimedia message comprises the step of re-encoding the audio format of the multimedia message to be compatible with the playback format of the terminal.

19. The computer program as recited in claim 12, wherein the code segment adapted to reformat the multimedia message comprises a code segment adapted to reducing the size of the multimedia message to a size compatible with the terminal.

20. The computer program as recited in claim 12, wherein the one or more capabilities of the terminal are obtained from the terminal.

21. The computer program as recited in claim 12, wherein the one or more capabilities of the terminal are obtained from a system cognizant of the one or more capabilities of the terminal.

22. The computer program as recited in claim 12, wherein the one or more capabilities of the terminal are obtained from commonly available known capabilities of the terminal.

23. A system for reformatting a multimedia message during connectionless communications, the system comprising:
a terminal;
a server that sends a first multimedia message notification to the terminal;
the server, whenever the terminal rejects delivery of the multimedia message,
requests one or more capabilities of the terminal,
reformats the multimedia message based on the requested capabilities, and
sends a second multimedia message notification to the terminal; and
the server sends the reformatted multimedia message to the terminal whenever the terminal accepts delivery of the multimedia message.

24. The system as recited in claim 23, wherein the server determines which of the requested capabilities caused the terminal to reject delivery of the multimedia message, and wherein the reformatting of the multimedia message is based on the requested capabilities that were determined to cause the terminal to reject delivery of the multimedia message.

25. The system as recited in claim 23, wherein the reformatting is optimized to maximize resolution of the content of the multimedia message.

26. The system as recited in claim 23, wherein reformatting of the multimedia message comprises converting the multimedia content within the multimedia message to a type compatible with the terminal.

27. The system as recited in claim 23, wherein reformatting of the multimedia message comprises converting the multimedia content within the multimedia message to a format compatible with the terminal.

28. The system as recited in claim 23, wherein reformatting of the multimedia message comprises converting the multimedia content within the multimedia message to a resolution compatible with the terminal.

29. The system as recited in claim 23, wherein reformatting of the multimedia message comprises reducing the size of the multimedia message to a size compatible with the terminal.

30. The method as recited in claim 23, wherein the step of reformatting the multimedia message comprises the step of re-encoding the audio format of the multimedia message to be compatible with the playback format of the terminal.

31. The system as recited in claim 23, wherein the one or more capabilities of the terminal are obtained from the terminal.

32. The system as recited in claim 23, wherein the one or more capabilities of the terminal are obtained from a system cognizant of the one or more capabilities of the terminal.

33. The system as recited in claim 23, wherein the one or more capabilities of the terminal are obtained from commonly available known capabilities of the terminal.
